(19) United States
(12) Patent Application Publication
(10) Pub. No.: US 2020/0229154 A1
(43) Pub. Date: Jul. 16, 2020

(54) USER TERMINAL AND RADIO COMMUNICATION METHOD

(71) Applicant: NTT DOCOMO, INC., Tokyo (JP)

(72) Inventors: Kazuki Takeda, Tokyo (JP); Satoshi Nagata, Tokyo (JP); Qin Mu, Beijing (CN); Liu Liu, Beijing (CN)

(73) Assignee: NTT DOCOMO, INC., Tokyo (JP)

(21) Appl. No.: 16/650,667

(22) PCT Filed: Sep. 29, 2017
(86) PCT No.: PCT/JP2017/035620

§ 371 Date: Mar. 25, 2020

(51) Int. Cl. H04W 72/04

(52) U.S. Cl. CPC H04W 72/042

(57) ABSTRACT

To prevent system capability from lowering even when communication is performed by applying a different downlink control channel configuration from those of legacy LTE systems, a user terminal includes: a receiving section that receives a downlink control channel; and a control section that controls determination of a plurality of first radio resources respectively associated with a plurality of downlink control channel candidates of a first aggregation level, and controls determination of a plurality of second radio resources of the plurality of first radio resources, the plurality of second radio resources being respectively associated with a plurality of downlink control channel candidates of a second aggregation level lower than the first aggregation level.

### TECHNICAL FIELD

The present invention relates to a user terminal and a radio communication method of a next-generation mobile communication system.

### BACKGROUND ART

In Universal Mobile Telecommunications System (UMTS) networks, for the purpose of higher data rates and lower latency, Long Term Evolution (LTE) has been specified (Non-Patent Literature 1). Furthermore, for the purpose of wider bands and a higher speed than those of LTE (also referred to as LTE Rel. 8 or 9), LTE-Advanced (also referred to as LTE-A or LTE Rel. 10, 11 or 12) has been specified. LTE successor systems (also referred to as, for example, Future Radio Access (FRA), the 5th generation mobile communication system (5G), 5G+ (plus), New Radio (NR), New radio access (NX), Future generation radio access (FX) or LTE Rel. 13, 14, 15 or subsequent releases) have been also studied.

Legacy LTE systems (e.g., LTE Rel. 8 to 13) perform communication on Downlink (DL) and/or Uplink (UL) by using subframes (also referred to as, for example, Transmission Time Intervals (TTIs)) of 1 ms. The subframe is a transmission time unit of 1 channel-coded data packet, and is a processing unit of scheduling, link adaptation and retransmission control (HARQ: Hybrid Automatic Repeat reQuest).

A radio base station controls allocation (scheduling) of data to a user terminal, and notifies the user terminal of scheduling of data by using Downlink Control Information (DCI). The user terminal monitors and performs reception processing (e.g., demodulation and decoding processing) on a downlink control channel (PDCCH: Physical Downlink Control Channel) on which the downlink control information is transmitted, and controls reception of DL data and/or transmission of uplink data based on the received downlink control information.

Transmission of downlink control channels (PDCCH/Enhanced Physical Downlink Control Channel (EPDCCH)) is controlled by using an aggregation of 1 or a plurality of Control Channel Elements (CCEs/Enhanced Control Channel Elements (ECCEs)). Furthermore, each control channel element includes a plurality of Resource Element Groups (REGs/Enhanced Resource Element Groups (EREGs)). The resource element group is used, too, when a control channel is mapped on a Resource Element (RE).

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8)”, April 2010

### SUMMARY OF INVENTION

### Technical Problem

Future radio communication systems (e.g., LTE Rel. 14, 15 and subsequent releases, 5G and NR) are assumed to control scheduling of data by a different configuration from those of legacy LTE systems (e.g., LTE Rel. 13 or prior releases). More specifically, the future radio communication systems are demanded to support flexible use of numerologies and a frequency, and realize a dynamic frame configuration. The numerologies refer to, for example, communication parameters (e.g., a subcarrier-spacing and a bandwidth) to be applied to transmission and reception of a certain signal.

Furthermore, it has been studied for the future radio communication systems to use for a control channel and/or a data channel a different configuration from those of the legacy LTE systems. There is a risk that use of a downlink control channel configuration of the legacy LTE system in a configuration different from those of the legacy LTE systems causes a decrease in capability such as deterioration of communication quality and/or a decrease in a throughput.

The present invention has been made in light of this point, and one of objects of the present invention is to provide a user terminal and a radio communication method that can prevent system capability from lowering even when communication is performed by applying a different downlink control channel configuration from those of legacy LTE systems.

### Solution to Problem

A user terminal according to one aspect of the present invention includes: a receiving section that receives a downlink control channel; and a control section that controls determination of a plurality of first radio resources respectively associated with a plurality of downlink control channel candidates of a first aggregation level, and controls determination of a plurality of second radio resources of the plurality of first radio resources, the plurality of second radio resources being respectively associated with a plurality of downlink control channel candidates of a second aggregation level lower than the first aggregation level.

### Advantageous Effects of Invention

According to the present invention, it is possible to prevent system capability from lowering even when communication is performed by applying a different downlink control channel configuration from those of legacy LTE systems.

### BRIEF DESCRIPTION OF DRAWINGS

FIGS. 1A and 1B are diagrams illustrating one example of downlink control channels of legacy LTE and future radio communication systems.

FIG. 2 is a diagram illustrating one example of highest AL candidates.

FIG. 3 is a diagram illustrating one example of an arrangement of PDCCH candidates according to a first aspect.

FIGS. 4A and 4B are diagrams illustrating one example of an arrangement of a plurality of highest AL candidates.

FIG. 5 is a diagram illustrating one example of an arrangement of PDCCH candidates according to a second aspect.

FIGS. 6A and 6B are diagrams illustrating one example of a highest AL determination method.

FIG. 7 is a diagram illustrating one example of a schematic configuration of a radio communication system according to one embodiment of the present invention.

FIG. 8 is a diagram illustrating one example of an overall configuration of a radio base station according to the one embodiment of the present invention.

FIG. 9 is a diagram illustrating one example of a function configuration of the radio base station according to the one embodiment of the present invention.

FIG. 10 is a diagram illustrating one example of an overall configuration of a user terminal according to the one embodiment of the present invention.

FIG. 11 is a diagram illustrating one example of a function configuration of the user terminal according to the one embodiment of the present invention.

FIG. 12 is a diagram illustrating one example of hardware configurations of the radio base station and the user terminal according to the one embodiment of the present invention.

### DESCRIPTION OF EMBODIMENTS

In legacy LTE systems, a radio base station transmits Downlink Control Information (DCI) by using a downlink control channel (e.g., a Physical downlink Control Channel (PDCCH) or an Enhanced PDCCH (EPDCCH)) to a UE. Transmission of the downlink control information may be read as transmission of a downlink control channel.

The DCI may be scheduling information including at least one of, for example, information indicating time/frequency resources for scheduling data, information indicating a transport block size, information indicating a data modulation scheme, information indicating an HARQ process identifier, and information related to a demodulation RS. The DCI for scheduling DL data reception and/or measurement of a DL reference signal may be referred to as a DL assignment or a DL grant, and the DCI for scheduling UL data transmission and/or transmission of a UL sounding (measurement) signal may be referred to as a UL grant.

The DL assignment and/or the UL grant may include information related to a resource, a sequence or a transmission format of a channel for transmitting a UL control signal (UCI: Uplink Control Information) such as HARQ-ACK feedback for DL data or channel measurement information (CSI: Channel State Information). Furthermore, the DCI for scheduling the UL control signal (UCI: Uplink Control Information) may be specified separately from the DL assignment and the UL grant. Which DCI of the DL assignment, the UL grant or UCI scheduling the DCI is may be decided based on which value a value of a specific bit field included in the DCI is, may be decided based on which one of a plurality of given values a DCI payload size is, or in which resource domain each DCI has been detected assuming that each DCI is mapped in advance in a different resource domain.

The UE is configured to monitor a set of a given number of downlink control channel candidates. In this regard, monitoring refers to, for example, trying to decode the set of each downlink control channel of a target DCI format. This decoding will be also referred to as Blind Decoding (BD) or blind detection. The downlink control channel candidate will be also referred to as a BD candidate or an (E)PDCCH candidate.

The PDCCH candidate set that needs to be monitored will be also referred to as a search space. A radio base station arranges DCI on given PDCCH candidates included in the search space. The UE blind-decodes one or more candidate resources in the search space, and detects DCI for the UE. The search space may be configured by a user-common higher layer signaling, or may be configured by a user-specific higher layer signaling. Furthermore, two or more search spaces may be configured to the user terminal on the same carrier.

Legacy LTE specifies a plurality of types of Aggregation Levels (ALs) for the search space for a purpose of link adaptation. The AL corresponds to the number of resource units (radio resources such as Control Channel Elements (CCEs)/Enhanced Control Channel Elements (ECCEs) having a given time duration and a given bandwidth) that compose DCI. Furthermore, the search space includes a plurality of PDCCH candidates for a certain AL.

A Cyclic Redundancy Check (CRC) bit is attached to the DCI. This CRC is masked (scrambled) by a UE-specific identifier (e.g., C-RNTI: Cell-Radio Network Temporary Identifier) or a system-common identifier. The UE can detect the DCI whose CRC has been scrambled by a C-RNTI associated with the own terminal, and the DCI whose CRC has been scrambled by the system-common identifier.

Furthermore, the search space includes a common search space that is commonly configured to UEs, and a UE-specific search space that is configured per UE. In the UE-specific search space of a PDCCH according to legacy LTE, the ALs (=the numbers of CCEs) are 1, 2, 4 and 8. The numbers of PDCCH candidates are specified as 6, 6, 2 and 2 for AL=1, 2, 4 and 8, respectively.

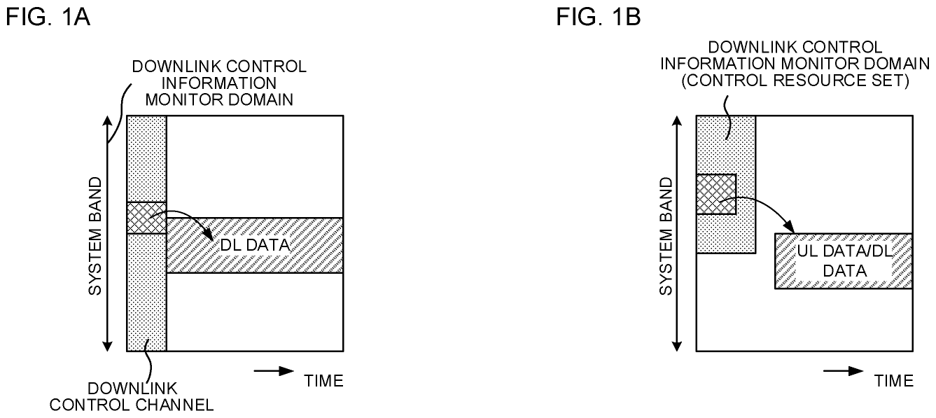

In legacy LTE systems, a downlink control channel (or downlink control information) is transmitted by using an entire system bandwidth (see FIG. 1A). Hence, the UE needs to monitor the entire system bandwidth and receive (blind-decode) the downlink control information irrespectively of whether or not DL data is allocated in each subframe.

By contrast with this, it is considered that the future radio communication systems do not perform communication by using the entire system band on a given carrier at all times, but dynamically or semi-statically configure a given frequency-domain (also referred to as a frequency band) based on, for example, communication use and/or communication environment, and control communication. For example, it is considered that the future radio communication systems do not necessarily allocate downlink control information for a certain UE to the entire system band and transmit the downlink control information, but configure a given frequency-domain and control transmission of the downlink control information (see FIG. 1B).

Furthermore, the control resource set (CORESET) is a frame (also referred to as a box, a set or a mass) of a resource on which the downlink control information is mapped or a time resource and/or a frequency resource in which an NR-PDCCH is arranged. Furthermore, the CORESET can be defined based on a resource unit size. For example, one CORESET size can be configured to a size that is an integer multiple of a specific resource unit size. Furthermore, the CORESET may include contiguous or non-contiguous resource units.

The resource unit is a unit of a resource to be allocated to the NR-PDCCH, and may be one of a Resource Block (an RB, a Physical Resource Block (PRB) and/or a Virtual Resource Block (VRB)), a PRB pair, an NR-CCE, an NR-REG and an NR-REG group.

The CORESET can be configured in a partial band (BWP: Bandwidth Part) that is at least part of a system bandwidth (carrier bandwidth) or a maximum bandwidth on which the user terminal can perform reception processing. The UE can monitor downlink control information within a range of the CORESET, and control reception of the downlink control information. This CORESET makes it unnecessary for the UE to monitor the entire system bandwidth at all times during the reception processing of the downlink control information, so that it is possible to reduce power consumption.

The UE may receive CORESET configuration information (configuration) and/or BWP configuration information (configuration) from the radio base station.

A nest (nesting) Search Space (SS) structure has been studied as a search space structure. By overlapping a plurality of search spaces (PDCCH candidates) having different ALs on the same radio resource, it is possible to reduce a channel estimation load for blind decoding in the UE.

According to the nest search space structure, a PDCCH candidate (lower AL candidate) having an AL (lower AL) lower than a highest AL is mapped on a PDCCH candidate (highest AL candidate) having the highest AL.

First, the highest AL candidate positions (CCEs) are determined. The highest AL candidates may include PDCCH candidates (actual highest AL candidates) that have the highest AL and need to be blind-decoded, or may include PDCCH candidates (pseudo highest AL candidates) that have the highest AL and do not need to be blind-decoded. When, for example, the AL is x={1, 2, 4, 8}, the number of highest AL candidates y is expressed by max(ceiling((number of PDCCH candidates whose AL is x)/(8/x))). The number of pseudo highest AL candidates may be configured together with the CORESET.

Next, lower AL candidates are mapped among the highest AL candidates.

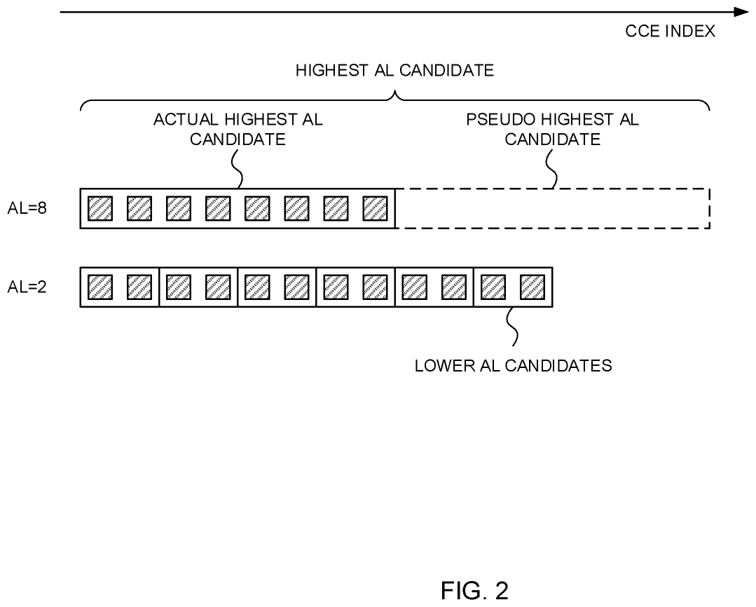

It is assumed that, as illustrated in, for example, FIG. 2, one PDCCH candidate whose AL is 8, and six PDCCH candidates whose AL is 2 are arranged. The one PDCCH candidate whose AL is 8 needs 8 CCEs, and the six PDCCH candidates whose AL is 2 needs 12 CCEs. That is, a total number of CCEs of the lower AL candidates is larger than a total number of CCEs of the actual highest AL candidates. Therefore, all lower AL candidates cannot be mapped on CCEs among the actual highest AL candidates. In this case, by arranging one actual highest AL candidate and one pseudo highest AL candidate as the highest AL candidates, and mapping the six lower AL candidates on the CCEs among the two highest AL candidates, it is possible to realize the nest search space structure.

Following two options are considered as a highest AL candidate position determination method.

Option 1: A PDCCH or an EPDCCH of LTE is used as a start point of the highest AL candidates. In this case, a plurality of PDCCH candidates having an identical AL are contiguously arranged.

Option 2: All highest AL candidates are randomly selected from a combination or a pattern of ALs in a CORESET.

Following three options are considered as a lower AL candidate position determination method.

Option 1: A PDCCH or an EPDCCH of LTE in all CCEs of a CORESET is used as a start point of lower AL candidates. In this case, the nest search space structure is not used. That is, lower AL candidate positions are determined independently from the highest AL candidates.

Option 2: The PDCCH or the EPDCCH of LTE in a CCE set included in the highest AL candidates is used as a start point of the lower AL candidates. In this case, the nest search space structure is used.

Option 3: The lower AL candidates are randomly selected from a combination or a pattern of ALs in CCEs included in the highest AL candidates. In this case, the nest search space structure is used.

However, a specific method for determining PDCCH candidate positions in the nest search space structure is not yet determined. Unless the PDCCH candidate positions are appropriately determined, there is a risk that a situation that PDCCH candidates are not allocated to the UE (blocking) occurs, i.e., system capability lowers. Hence, the inventors of this application have studied highest AL candidate and lower AL candidate position determination methods, and invented the present invention.

An embodiment according to the present invention will be described in detail below with reference to the drawings. A radio communication method according to each embodiment may be each applied alone or may be applied in combination.

(Radio Communication Method)

<First Aspect>

According to the first aspect, when a nest search space structure is used, and a plurality of highest AL candidates and a plurality of lower AL candidates are arranged, a plurality of lower AL candidates may be equally or unequally distributed to a plurality of highest AL candidates. Each lower AL candidate is associated with one of a plurality of highest AL candidates, and is arranged in the associated highest AL candidate. The highest AL candidates may be referred to as parent candidates, and the lower AL candidates arranged in the parent candidates may be referred to as child candidates.

Furthermore, positions of a plurality of lower AL candidates associated with each highest AL candidate is independently randomized per highest AL candidate. An equation for randomizing the lower AL candidate positions in different highest AL candidates may be different.

An example where a plurality of lower AL candidates are equally distributed to a plurality of highest AL candidates will be described below. A difference between the numbers of lower AL candidates having a certain AL may be 1 or less between the highest AL candidates.

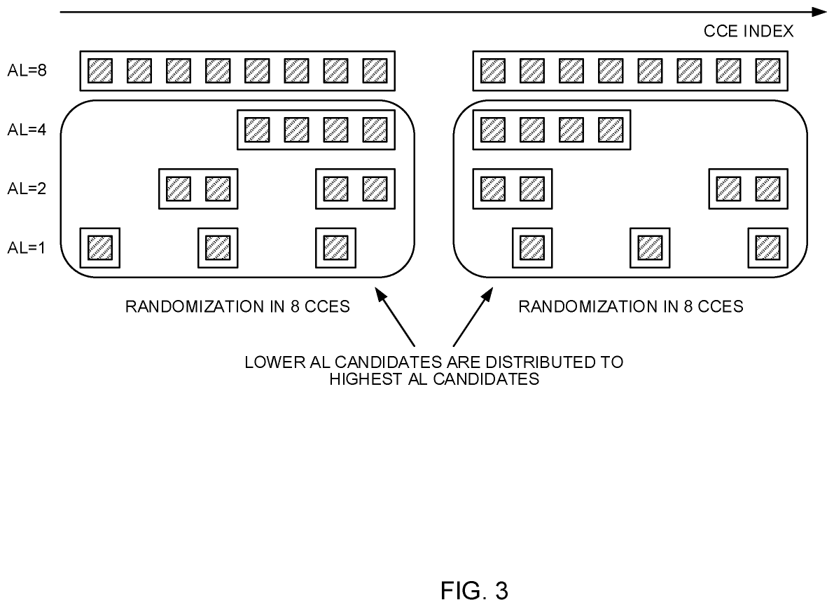

FIG. 3 is a diagram illustrating one example of an arrangement of PDCCH candidates according to the first aspect. In the example in FIG. 3, a plurality of lower AL candidates having each AL are equally distributed to two highest AL candidates. That is, the same number of lower AL candidates is included in each highest AL candidate per AL. Furthermore, lower AL candidate positions are randomized in 8 CCEs occupied by each highest AL candidate.

As illustrated in FIG. 3, as the AL becomes lower, the number of PDCCH candidates at the AL may become larger.

A radio base station may determine highest AL candidate positions by using a highest AL candidate position determination method, determine lower AL candidate positions by using a lower AL candidate position determination method, and transmit DCI by using the determined PDCCH candidates. In this regard, the radio base station may not transmit DCI by using a pseudo highest AL candidate.

A UE may determine the highest AL candidate positions by using the highest AL candidate position determination method, determine lower AL candidate positions by using the lower AL candidate position determination method, and blind-decode the determined PDCCH candidates. In this regard, the UE may not blind-decode the pseudo highest AL candidate.

<<Highest AL Candidate Position Determination Method>>

For example, following two options are considered as the highest AL candidate position determination method.

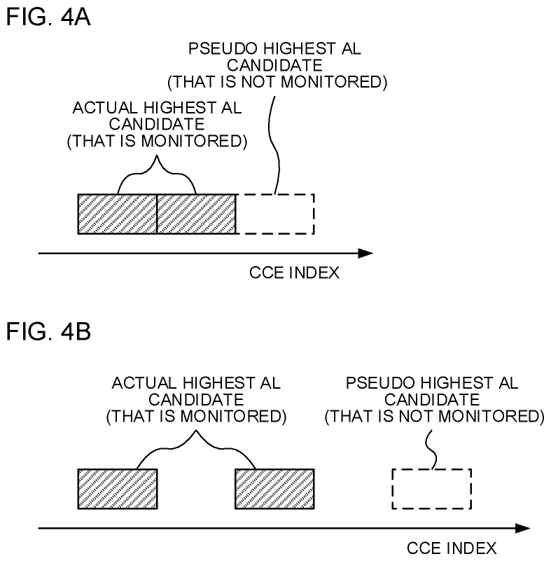

Option 1: As illustrated in FIG. 4A, a plurality of highest AL candidates have contiguous CCE indices. This highest AL candidate arrangement may be referred to as a local arrangement. CCEs in each highest AL candidate are contiguous (each highest AL candidate has contiguous CCE indices). Furthermore, a CCE having a smallest index (smallest CCE index) of the highest AL candidate may be selected from CCE indices that are multiples of the AL. When, for example, the highest AL is 8, the CCE of the smallest index of the highest AL candidate is 8n (n is an integer).

When, for example, a total number of CCEs of the lower AL candidates having a specific AL is larger than a total number of CCEs of actual highest AL candidates, a pseudo highest AL candidate is arranged. When a pseudo highest AL candidate is used as illustrated in FIG. 4A, a position of the pseudo highest AL candidate (a PDCCH candidate that is not monitored) is determined by using the same determination method (equation) as that of positions of actual highest AL candidates (PDCCH candidates that are monitored). For example, the pseudo highest AL candidate is arranged on a CCE continuing from the actual highest AL candidates.

The radio base station and the UE may each identify the smallest CCE index (first CCE index) of each highest AL candidate by using a specific equation.

For example, the specific equation is a hash function expressed by following equation (1).

[Mathematical 1]

L{(Yₖ+m)mod └N_{CCE,k}/L┘}+i (Equation 1)

Yₖ=(A·Yₖ₋₁)mod D (Equation 2)

In equation (1), N_{CCE, k} is a total number of CCEs included in a CORESET k. L represents an aggregation level, and is, for example, L∈{2, 4, 8}. L described herein is the highest AL. i is 0, . . . , L−1. A PDCCH candidate number m is 0, . . . , M^{(L)}−1. Furthermore, M^{(L)} represents the number of PDCCH candidates at the aggregation level L.

Yₖ is defined by equation (2). In equation (2), for example, Y₋₁=n_{RNTI}±0, A=39827, D=65537 and k=nₛ. nₛ represents a slot number in a radio frame. n_{RNTI} is a Radio Network Temporary ID (RNTI) that differs per UE.

The hash function may use symbol numbers of CORESETs and/or PDCCH candidates. CORESET configuration information may include the symbol numbers.

The radio base station and the UE may each identify the smallest CCE index of the first highest AL candidate by using an equation having some parameters. The some parameters may be all or one of the total number of CCEs in the CORESET, an AL, slot and/or symbol numbers, a UE-ID and/or an RNTI, physical and/or virtual cell IDs, and a CORESET-specific offset.

According to this equation, it is possible to randomize inter-cell and/or inter-UE interferences. By, for example, making the PDCCH candidates hop per slot and/or symbol, it is possible to suppress a contention probability of the PDCCH candidates and suppress the interferences.

Option 2: As illustrated in FIG. 4B, a plurality of highest AL candidates are dispersed (are apart from each other) in the CORESET. This highest AL candidate arrangement may be referred to as a dispersed arrangement. CCEs in each highest AL candidate are contiguous. Furthermore, a CCE having a smallest index (smallest CCE index) of the highest AL candidate may be selected from CCE indices that are multiples of the AL. When, for example, the highest AL is 8, the CCE of the smallest index of the highest AL candidate is 8n (n is an integer).

When a pseudo highest AL candidate is used as illustrated in FIG. 4B, a position of the pseudo highest AL candidate (a PDCCH candidate that is not monitored) is determined by using the same determination method (equation) as that of positions of actual highest AL candidates (PDCCH candidates that are monitored). For example, the pseudo highest AL candidate is arranged on the CCE subsequent to the actual highest AL candidates.

The radio base station and the UE may each identify the smallest CCE index (first CCE index) of each highest AL candidate by using a specific equation. For example, the specific equation is a hash function expressed by following equation (3).

[Mathematical 2]

L{(Yₖ+m└N_{CCE,k}/L┘)mod └N_{CCE,k}/L┘}+i (Equation 3)

Yₖ=(A·Yₖ₋₁)mod D (Equation 4)

Parameters in equation (3) are the same as the parameters in equation (1).

Yₖ is defined by equation (4). Parameters in equation (4) are the same as the parameters in equation (2).

The hash function may use other parameters such as symbol numbers of CORESETs and/or PDCCH candidates.

The radio base station and the UE may each identify the smallest CCE index of the first highest AL candidate by using an equation having some parameters. The some parameters may be all or one of the total number of CCEs in the CORESET, an AL, slot and/or symbol numbers, a UE-ID and/or an RNTI, physical and/or virtual cell IDs, and a CORESET-specific offset.

<<Lower AL Candidate Position Determination Method>>

Lower AL candidates associated with a certain highest AL candidate are randomized in CCEs of this highest AL candidate.

For example, following two options are considered as the lower AL candidate position determination method.

Option 1: The lower AL candidates are not limited to the highest AL candidates. In this case, the nest search space structure is not used. In other words, the lower AL candidate positions are determined independently from the highest AL candidate position. In this case, the lower AL candidates may not be arranged in CCEs of the highest AL candidate.

Following two options are considered as a specific example of the option 1.

Option 1-1: Similar to the option 1 of the highest AL candidate position determination method, the lower AL candidate positions are determined. That is, a plurality of lower AL candidates have contiguous CCE indices. Furthermore, a CCE having a smallest index (smallest CCE index) of the lowest AL candidate may be selected from CCE indices that are multiples of the AL. When, for example, the AL is 2, a CCE of the smallest index of the lowest AL candidate is 2n (n is an integer).

Option 1-2: Similar to the option 2 of the highest AL candidate position determination method, the lower AL candidate positions are determined. That is, a plurality of lower AL candidates are dispersed (are apart from each other) in the CORESET. Furthermore, a CCE having a smallest index (smallest CCE index) of the lower AL candidate may be selected from CCE indices that are multiples of the AL. When, for example, the AL is 2, a CCE of the smallest index of the lowest AL candidate is 2n (n is an integer).

Option 2: The lower AL candidates are limited to the highest AL candidates. In this case, the nest search space structure is used.

PDCCH candidates having a specific AL lower than the highest AL will be referred to as specific AL candidates. Assuming that the total number of highest AL candidates is Mₓ, and the total number of specific AL candidates is M_{y}, the M_{y} specific AL candidates are first grouped into a group associated with the Mₓ highest AL candidates, and are associated with the highest AL candidate. Each group has ceiling(M_{y}/Mₓ) PDCCH candidates. This grouping associates each highest AL candidate with a substantially identical number of specific AL candidates. That is, a difference between the numbers of specific AL candidates associated with each highest AL candidate is 1 or less. Hence, the M_{y} specific AL candidates are equally dispersed.

Next, each specific AL candidate in a specific AL candidate group associated with an xth highest AL candidate is mapped in CCEs that belong to the xth highest AL candidate.

The radio base station and the UE may each identify the smallest CCE index of each specific AL candidate in the specific AL candidate group associated with the xth highest AL candidate by using an equation in which N_{CCE, k} in the specific equation (equation (1) or equation (3)) for identifying the smallest CCE index of the highest AL candidate with the number of CCEs N_{XCCE, k} of the highest AL candidate. By using this equation, it is possible to commonalize calculation of the highest AL candidate positions and calculation of the lower AL candidate positions, and simplify processing of the radio base station and the UE.

According to the above first aspect, by equally distributing the lower AL candidates to a plurality of highest AL candidates, the lower AL candidates are equally arranged in a plurality of highest AL candidates in every UE, so that it is possible to make a blocking probability between the UEs equal. Furthermore, by equally distributing the lower AL candidates to a plurality of highest AL candidates, it is possible to simplify a scheduler in the radio base station.

<Second Aspect>

According to the second aspect, lower AL candidate positions are randomized in all resources occupied by highest AL candidates.

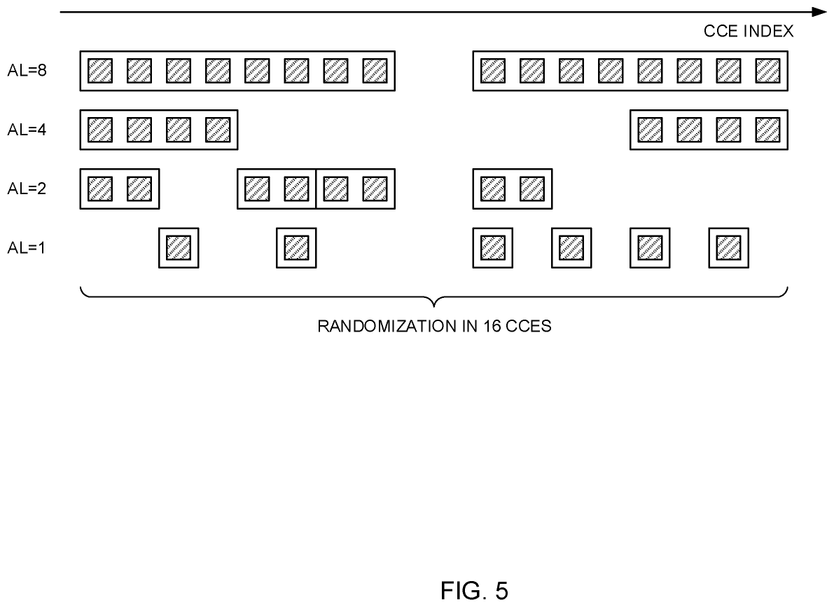

FIG. 5 is a diagram illustrating one example of an arrangement of PDCCH candidates according to the second aspect. In the example in FIG. 5, the lower AL candidate positions are randomized in 16 CCEs occupied by two highest AL candidates.

A radio base station may determine highest AL candidate positions by using a highest AL candidate position determination method, determine lower AL candidate positions by using a lower AL candidate position determination method, and transmit DCI by using the determined PDCCH candidates. In this regard, the radio base station may not transmit DCI by using a pseudo highest AL candidate.

A UE may determine the highest AL candidate positions by using the highest AL candidate position determination method, determine lower AL candidate positions by using the lower AL candidate position determination method, and blind-decode the determined PDCCH candidates. In this regard, the UE may not blind-decode the pseudo highest AL candidate.

<<Highest AL Candidate Position Determination Method>>

For example, following two options are considered as the highest AL candidate position determination method.

Option 1: As illustrated in above-described FIG. 4A, a plurality of highest AL candidates have contiguous CCE indices. This highest AL candidate arrangement may be referred to as a local arrangement. CCEs in each highest AL candidate are contiguous.

When there is the pseudo highest AL candidate as illustrated in above-described FIG. 4A, the pseudo highest AL candidate is arranged similar to the actual highest AL candidates. For example, the pseudo highest AL candidate is arranged on a CCE continuing from the actual highest AL candidates.

The radio base station and the UE may each identify the smallest CCE index (first CCE index) of each highest AL candidate by using a specific equation.

For example, the specific equation is a hash function expressed by following equation (1). The hash function may have other parameters such as symbol numbers of CORESETs and/or PDCCH candidates.

The radio base station and the UE may each identify the smallest CCE index of the first highest AL candidate by using an equation having some parameters. The some parameters may be all or one of the total number of CCEs in the CORESET, an AL, slot and/or symbol numbers, a UE-ID and/or an RNTI, physical and/or virtual cell IDs, and a CORESET-specific offset.

Option 2: As illustrated in above-described FIG. 4B, a plurality of highest AL candidates are dispersed (are apart from each other) in the CORESET. This highest AL candidate arrangement may be referred to as a dispersed arrangement. CCEs in each highest AL candidate are contiguous.

When there is the pseudo highest AL candidate as illustrated in above-described FIG. 4B, the pseudo highest AL candidate is arranged similar to the actual highest AL candidate. For example, the pseudo highest AL candidate is arranged on the CCE subsequent to the actual highest AL candidates.

The radio base station and the UE may each identify the smallest CCE index (first CCE index) of each highest AL candidate by using a specific equation.

For example, the specific equation is a hash function expressed by following equation (3). The hash function may use other parameters such as symbol numbers of CORESETs and/or PDCCH candidates.

The radio base station and the UE may each identify the smallest CCE index of the first highest AL candidate by using an equation having some parameters. The some parameters may be all or one of the total number of CCEs in the CORESET, an AL, slot and/or symbol numbers, a UE-ID and/or an RNTI, physical and/or virtual cell IDs, and a CORESET-specific offset.

<<Lower AL Candidate Position Determination Method>>

For example, following two options are considered as the lower AL candidate position determination method.

Option 1: The lower AL candidates are not limited to the highest AL candidates. When a nest search space structure is not used, the option 1 may be used. In other words, the lower AL candidate positions are determined independently from the highest AL candidate position. In this case, the lower AL candidates may not be arranged in CCEs of the highest AL candidate.

Following two options are considered as a specific example of the option 1.

Option 1-1: Similar to the option 1 of the highest AL candidate position determination method, the lower AL candidate positions are determined. That is, a plurality of lower AL candidates have contiguous CCE indices.

Option 1-2: Similar to the option 2 of the highest AL candidate position determination method, the lower AL candidate positions are determined. That is, a plurality of lower AL candidates are dispersed (are apart from each other) in the CORESET.

Option 2: The lower AL candidates are limited to the highest AL candidates. When the nest search space structure is used, the option 2 may be used.

Following two options are considered as a specific example of the option 1.

Option 2-1: The radio base station and the UE may each identify the smallest CCE index (first CCE index) of each lower AL candidate by using a specific equation. CCEs in each lower AL candidate are contiguous.

For example, the specific equation is a hash function expressed by equation (1). The hash function may have other parameters such as symbol numbers of CORESETs and/or PDCCH candidates.

The radio base station and the UE may each identify the smallest CCE index of the first lower AL candidate by using an equation having some parameters. The equation for identifying the smallest CCE index of the lower AL candidate uses a total number of CCEs of all highest AL candidates instead of a total number of CCEs in a CORESET in the equation for identifying the smallest CCE index of the first highest AL candidate according to the option 1 of the highest AL candidate position determination method. By using these equations, it is possible to commonalize calculation of the highest AL candidate positions and calculation of the lower AL candidate positions, and simplify processing of the radio base station and the UE.

Option 2-2: A plurality of lower AL candidates are dispersed (are apart from each other) in the CORESET. The radio base station and the UE may each identify the smallest CCE index (first CCE index) of each lower AL candidate by using a specific equation. CCEs in each lower AL candidate are contiguous.

For example, the specific equation is a hash function expressed by equation (3). The hash function may use other parameters such as symbol numbers of CORESETs and/or PDCCH candidates.

The radio base station and the UE may each identify the smallest CCE index of the first lower AL candidate by using an equation having some parameters. The equation for identifying the smallest CCE index of the lower AL candidate uses a total number of CCEs of all highest AL candidates instead of a total number of CCEs in a CORESET in the equation for identifying the smallest CCE index of the first highest AL candidate according to the option 2 of the highest AL candidate position determination method. By using these equations, it is possible to commonalize calculation of the highest AL candidate positions and calculation of the lower AL candidate positions, and simplify processing of the radio base station and the UE.

According to the above second aspect, processing of distributing lower AL candidates to highest AL candidates as in the first aspect is not necessary, so that it is possible to simplify processing of the radio base station and the UE.

<Third Aspect>

The third aspect will describe a highest AL determination method. The third aspect may be combined with the first or second aspect.

Following three options are considered as the highest AL.

Option 1: The highest AL may be the number of CCEs occupied by one PDCCH candidate (actual highest AL candidate) of the highest AL (actual highest AL) that is actually monitored. In this case, the highest AL candidate does not include a pseudo highest AL candidate.

The UE may determine the highest AL based on the number of CCEs occupied by one actual highest AL candidate. Furthermore, a UE may determine CCEs of lower AL candidates among the CCEs occupied by all actual highest AL candidates.

Option 2: The number of highest AL candidates y may be determined by a given equation. When, for example, the AL is x={1, 2, 4, 8}, y is expressed by max(ceiling((number of PDCCH candidates whose AL is x)/(8/x))). In this case, the highest AL candidates may include pseudo highest AL candidates. The UE may determine the number of highest AL candidates y by using the given equation.

Option 3: The highest AL may be configured by the radio base station to the UE by a higher layer signaling. The higher layer signaling may be at least one of a Radio Resource Control (RRC) signaling, broadcast information (a Master Information Block (MIB) or a System Information Block (SIB)), and a Medium Access Control (MAC) signaling. The highest AL notified by the higher layer signaling may be a highest value (actual highest AL) of the AL that is blind-decoded, and/or a highest value (pseudo highest AL) of the AL that is not blind-decoded.

The number of pseudo highest AL candidates may be equal to the number of actual highest AL candidates. In this case, the UE may receive one of the numbers of the actual highest AL candidates and the pseudo highest AL candidates by the higher layer signaling, and determine the other one of the numbers based on the received number.

The highest AL notified by the higher layer signaling may be a pseudo highest AL. The pseudo highest AL may be higher than the actual highest AL. In this case, the highest AL candidates are the pseudo highest AL candidates.

The option 3 enables higher flexibility. For example, according to the option 3, it is possible to improve a balance between a load of channel estimation for blind decoding in the UE and a blocking probability.

When the radio base station configures the pseudo highest AL to the UE in the option 3, the blocking probability according to the option 3 can be made smaller than blocking probabilities according to the option 1 and the option 2.

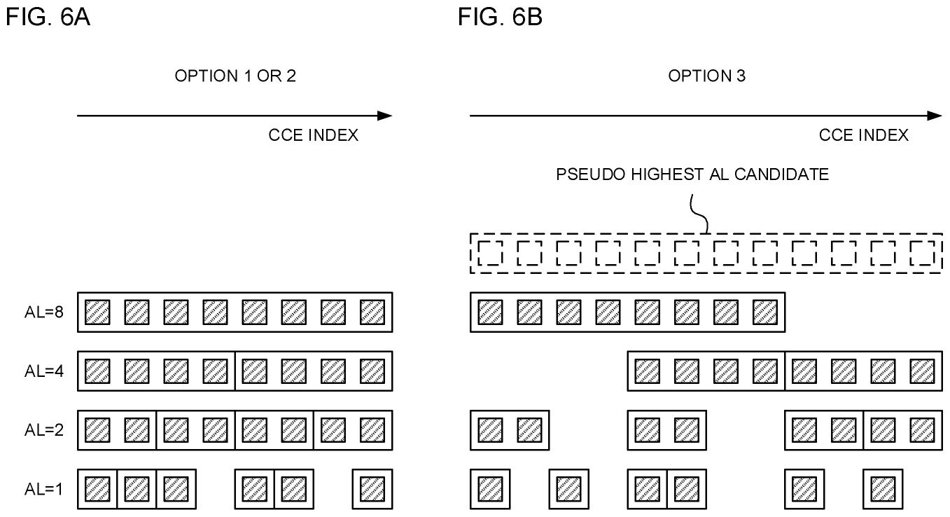

The example in FIG. 6 assumes that the actual highest AL is 8. As illustrated in FIG. 6A, the highest AL determined according to the option 1 or 2 is 8. When 12 is configured as the pseudo highest AL according to the option 3 as illustrated in FIG. 6B, the highest AL is 12. In this case, the UE does not monitor the highest AL candidates (pseudo highest AL candidates), and monitors the lower AL candidates (whose AL is 8 or less).

The number of PDCCH candidates to be monitored is equal between FIGS. 6A and 6B. On the other hand, the highest AL in FIG. 6B is higher than the highest AL in FIG. 6A, so that it is possible to increase the number of CCEs belonging to the highest AL candidates, expand a range of the CCEs on which the lower AL candidates can be mapped, and suppress a blocking probability.

(Radio Communication System)

The configuration of the radio communication system according to one embodiment of the present invention will be described below. This radio communication system uses one or a combination of the radio communication method according to each of the above embodiment of the present invention to perform communication.

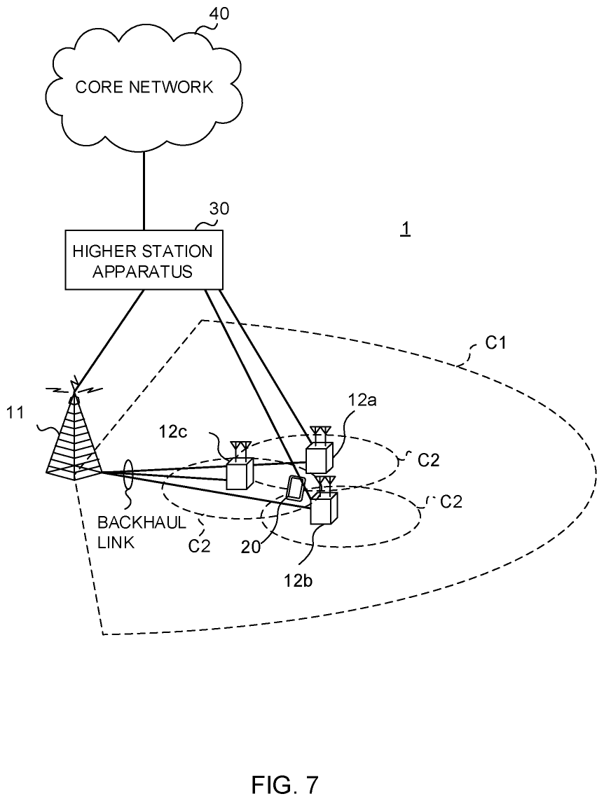

FIG. 7 is a diagram illustrating one example of a schematic configuration of the radio communication system according to the one embodiment of the present invention. A radio communication system 1 can apply Carrier Aggregation (CA) and/or Dual Connectivity (DC) that aggregate a plurality of base frequency blocks (component carriers) whose 1 unit is a system bandwidth (e.g., 20 MHz) of the LTE system.

In this regard, the radio communication system 1 may be referred to as Long Term Evolution (LTE), LTE-Advanced (LTE-A), LTE-Beyond (LTE-B), SUPER 3G, IMT-Advanced, the 4th generation mobile communication system (4G), the 5th generation mobile communication system (5G), New Radio (NR), Future Radio Access (FRA) and the New Radio Access Technology (New-RAT), or a system that realizes these techniques.

The radio communication system 1 includes a radio base station 11 that forms a macro cell C1 of a relatively wide coverage, and radio base stations 12 (12a to 12c) that are located in the macro cell C1 and form small cells C2 narrower than the macro cell C1. Furthermore, a user terminal 20 is located in the macro cell C1 and each small cell C2. An arrangement and the numbers of respective cells and user terminals 20 are not limited to those illustrated in FIG. 7.

The user terminal 20 can connect with both of the radio base station 11 and the radio base stations 12. The user terminal 20 is assumed to concurrently use the macro cell C1 and the small cells C2 by CA or DC. Furthermore, the user terminal 20 may apply CA or DC by using a plurality of cells (CCs) (e.g., five CCs or less or six CCs or more).

The user terminal 20 and the radio base station 11 can communicate by using a carrier (also referred to as a legacy carrier) of a narrow bandwidth in a relatively low frequency band (e.g., 2 GHz). On the other hand, the user terminal 20 and each radio base station 12 may use a carrier of a wide bandwidth in a relatively high frequency band (e.g., 3.5 GHz or 5 GHz) or may use the same carrier as that used between the user terminal 20 and the radio base station 11. In this regard, a configuration of the frequency band used by each radio base station is not limited to this.

The radio base station 11 and each radio base station 12 (or the two radio base stations 12) can be configured to be connected by way of wired connection (e.g., optical fibers compliant with a Common Public Radio Interface (CPRI) or an X2 interface) or radio connection.

The radio base station 11 and each radio base station 12 are each connected with a higher station apparatus 30 and connected with a core network 40 via the higher station apparatus 30. In this regard, the higher station apparatus 30 includes, for example, an access gateway apparatus, a Radio Network Controller (RNC) and a Mobility Management Entity (MME), yet is not limited to these. Furthermore, each radio base station 12 may be connected with the higher station apparatus 30 via the radio base station 11.

In this regard, the radio base station 11 is a radio base station that has a relatively wide coverage, and may be referred to as a macro base station, an aggregate node, an eNodeB (eNB) or a transmission/reception point. Furthermore, each radio base station 12 is a radio base station that has a local coverage, and may be referred to as a small base station, a micro base station, a pico base station, a femto base station, a Home eNodeB (HeNB), a Remote Radio Head (RRH) or a transmission/reception point. The radio base stations 11 and 12 will be collectively referred to as a radio base station 10 below when not distinguished.

Each user terminal 20 is a terminal that supports various communication schemes such as LTE and LTE-A, and may include not only a mobile communication terminal (mobile station) but also a fixed communication terminal (fixed station).

The radio communication system 1 applies Orthogonal Frequency-Division Multiple Access (OFDMA) to downlink and applies Single Carrier-Frequency Division Multiple Access (SC-FDMA) and/or OFDMA to uplink as radio access schemes.

OFDMA is a multicarrier transmission scheme that divides a frequency band into a plurality of narrow frequency bands (subcarriers) and maps data on each subcarrier to perform communication. SC-FDMA is a single carrier transmission scheme that divides a system bandwidth into bands including one or contiguous resource blocks per terminal and causes a plurality of terminals to use respectively different bands to reduce an inter-terminal interference. In this regard, uplink and downlink radio access schemes are not limited to a combination of these, and other radio access schemes may be used.

The radio communication system 1 uses a downlink shared channel (PDSCH: Physical Downlink Shared Channel) shared by each user terminal 20, a broadcast channel (PBCH: Physical Broadcast Channel) and a downlink L1/L2 control channel as downlink channels. User data, higher layer control information and System Information Blocks (SIBs) are conveyed on the PDSCH. Furthermore, Master Information Blocks (MIBs) are conveyed on the PBCH.

The downlink L1/L2 control channel includes a Physical Downlink Control Channel (PDCCH), an Enhanced Physical Downlink Control Channel (EPDCCH), a Physical Control Format Indicator Channel (PCFICH), and a Physical Hybrid-ARQ Indicator Channel (PHICH). Downlink Control Information (DCI) including scheduling information of the PDSCH and/or the PUSCH is conveyed on the PDCCH.

In addition, the scheduling information may be notified by the DCI. For example, DCI for scheduling DL data reception may be referred to as a DL assignment, and DCI for scheduling UL data transmission may be referred to as a UL grant.

The number of OFDM symbols used for the PDCCH is conveyed on the PCFICH. Transmission acknowledgement information (also referred to as, for example, retransmission control information, HARQ-ACK or ACK/NACK) of a Hybrid Automatic Repeat reQuest (HARQ) for the PUSCH is conveyed on the PHICH. The EPDCCH is subjected to frequency division multiplexing with the PDSCH (downlink shared data channel) and is used to convey DCI similar to the PDCCH.

The radio communication system 1 uses an uplink shared channel (PUSCH: Physical Uplink Shared Channel) shared by each user terminal 20, an uplink control channel (PUCCH: Physical Uplink Control Channel), and a random access channel (PRACH: Physical Random Access Channel) as uplink channels. User data and higher layer control information are conveyed on the PUSCH. Furthermore, downlink radio quality information (CQI: Channel Quality Indicator), transmission acknowledgement information and a Scheduling Request (SR) are conveyed on the PUCCH. A random access preamble for establishing connection with a cell is conveyed on the PRACH.

The radio communication system 1 conveys a Cell-specific Reference Signal (CRS), a Channel State Information-Reference Signal (CSI-RS), a DeModulation Reference Signal (DMRS) and a Positioning Reference Signal (PRS) as downlink reference signals. Furthermore, the radio communication system 1 conveys a Sounding Reference Signal (SRS) and a DeModulation Reference Signal (DMRS) as uplink reference signals. In this regard, the DMRS may be referred to as a user terminal-specific reference signal (UE-specific Reference Signal). Furthermore, a reference signal to be conveyed is not limited to these.

<Radio Base Station>

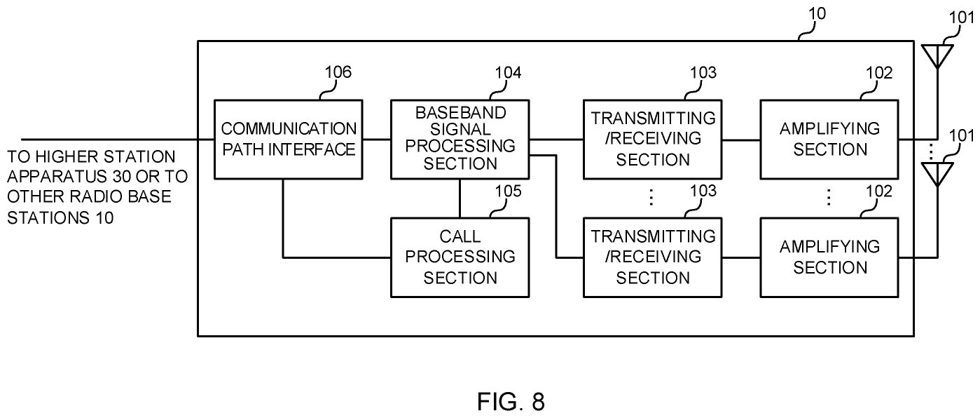

FIG. 8 is a diagram illustrating one example of an overall configuration of the radio base station according to the one embodiment of the present invention. The radio base station 10 includes pluralities of transmission/reception antennas 101, amplifying sections 102 and transmitting/receiving sections 103, a baseband signal processing section 104, a call processing section 105 and a communication path interface 106. In this regard, the radio base station 10 only needs to be configured to include one or more of each of the transmission/reception antennas 101, the amplifying sections 102 and the transmitting/receiving sections 103.

User data transmitted from the radio base station 10 to the user terminal 20 on downlink is input from the higher station apparatus 30 to the baseband signal processing section 104 via the communication path interface 106.

The baseband signal processing section 104 performs processing of a Packet Data Convergence Protocol (PDCP) layer, segmentation and concatenation of the user data, transmission processing of a Radio Link Control (RLC) layer such as RLC retransmission control, Medium Access Control (MAC) retransmission control (e.g., HARQ transmission processing), and transmission processing such as scheduling, transmission format selection, channel coding, Inverse Fast Fourier Transform (IFFT) processing, and precoding processing on the user data, and transfers the user data to each transmitting/receiving section 103. Furthermore, the baseband signal processing section 104 performs transmission processing such as channel coding and inverse fast Fourier transform on a downlink control signal, too, and transfers the downlink control signal to each transmitting/receiving section 103.

Each transmitting/receiving section 103 converts a baseband signal precoded and output per antenna from the baseband signal processing section 104 into a radio frequency range, and transmits a radio frequency signal. The radio frequency signal subjected to frequency conversion by each transmitting/receiving section 103 is amplified by each amplifying section 102, and is transmitted from each transmission/reception antenna 101. The transmitting/receiving sections 103 can be composed of transmitters/receivers, transmission/reception circuits or transmission/reception apparatuses described based on a common knowledge in a technical field according to the present invention. In this regard, the transmitting/receiving sections 103 may be composed as an integrated transmitting/receiving section or may be composed of transmission sections and reception sections.

Meanwhile, each amplifying section 102 amplifies a radio frequency signal received by each transmission/reception antenna 101 as an uplink signal. Each transmitting/receiving section 103 receives the uplink signal amplified by each amplifying section 102. Each transmitting/receiving section 103 performs frequency conversion on the received signal into a baseband signal, and outputs the baseband signal to the baseband signal processing section 104.

The baseband signal processing section 104 performs Fast Fourier Transform (FFT) processing, Inverse Discrete Fourier Transform (IDFT) processing, error correcting decoding, MAC retransmission control reception processing, and reception processing of an RLC layer and a PDCP layer on user data included in the input uplink signal, and transfers the user data to the higher station apparatus 30 via the communication path interface 106. The call processing section 105 performs call processing (such as configuration and release) of a communication channel, state management of the radio base station 10, and radio resource management.

The communication path interface 106 transmits and receives signals to and from the higher station apparatus 30 via a given interface. Furthermore, the communication path interface 106 may transmit and receive (backhaul signaling) signals to and from the another radio base station 10 via an inter-base station interface (e.g., optical fibers compliant with the Common Public Radio Interface (CPRI) or the X2 interface).

Furthermore, each transmitting/receiving section 103 may transmit a downlink control channel (e.g., PDCCH).

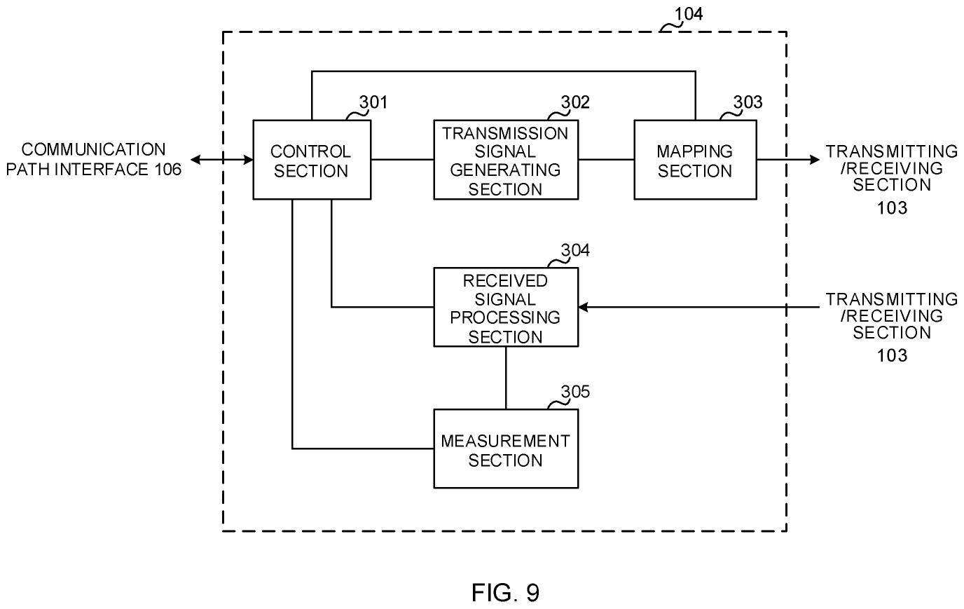

FIG. 9 is a diagram illustrating one example of a function configuration of the radio base station according to the one embodiment of the present invention. In addition, this example mainly illustrates function blocks of characteristic portions according to the present embodiment, and assumes that the radio base station 10 includes other function blocks, too, that are necessary for radio communication.

The baseband signal processing section 104 includes at least a control section (scheduler) 301, a transmission signal generating section 302, a mapping section 303, a received signal processing section 304 and a measurement section 305. In addition, these components only need to be included in the radio base station 10, and part or all of the components may not be included in the baseband signal processing section 104.

The control section (scheduler) 301 controls the entire radio base station 10. The control section 301 can be composed of a controller, a control circuit or a control apparatus described based on the common knowledge in the technical field according to the present invention.

The control section 301 controls, for example, signal generation of the transmission signal generating section 302 and signal allocation of the mapping section 303. Furthermore, the control section 301 controls signal reception processing of the received signal processing section 304 and signal measurement of the measurement section 305.

The control section 301 controls scheduling (e.g., resource allocation) of system information, a downlink data signal (e.g., a signal that is transmitted on the PDSCH), and a downlink control signal (e.g., a signal that is transmitted on the PDCCH and/or the EPDCCH and is, for example, transmission acknowledgement information). Furthermore, the control section 301 controls generation of a downlink control signal and a downlink data signal based on a result obtained by deciding whether or not it is necessary to perform retransmission control on an uplink data signal. Furthermore, the control section 301 controls scheduling of synchronization signals (e.g., a Primary Synchronization Signal (PSS)/a Secondary Synchronization Signal (SSS)) and downlink reference signals (e.g., a CRS, a CSI-RS and a DMRS).

Furthermore, the control section 301 controls scheduling of an uplink data signal (e.g., a signal that is transmitted on the PUSCH), an uplink control signal (e.g., a signal that is transmitted on the PUCCH and/or the PUSCH and is, for example, transmission acknowledgement information), a random access preamble (e.g., a signal that is transmitted on the PRACH) and an uplink reference signal.

The transmission signal generating section 302 generates a downlink signal (such as a downlink control signal, a downlink data signal or a downlink reference signal) based on an instruction from the control section 301, and outputs the downlink signal to the mapping section 303. The transmission signal generating section 302 can be composed of a signal generator, a signal generating circuit or a signal generating apparatus described based on the common knowledge in the technical field according to the present invention.

The transmission signal generating section 302 generates, for example, a DL assignment for notifying downlink data allocation information, and/or a UL grant for notifying uplink data allocation information based on the instruction from the control section 301. The DL assignment and the UL grant are both DCI, and conform to a DCI format. Furthermore, the transmission signal generating section 302 performs encoding processing and modulation processing on a downlink data signal according to a code rate and a modulation scheme determined based on Channel State Information (CSI) from each user terminal 20.

The mapping section 303 maps the downlink signal generated by the transmission signal generating section 302, on given radio resources based on the instruction from the control section 301, and outputs the downlink signal to each transmitting/receiving section 103. The mapping section 303 can be composed of a mapper, a mapping circuit or a mapping apparatus described based on the common knowledge in the technical field according to the present invention.

The received signal processing section 304 performs reception processing (e.g., demapping, demodulation and decoding) on a received signal input from each transmitting/receiving section 103. In this regard, the received signal is, for example, an uplink signal (such as an uplink control signal, an uplink data signal or an uplink reference signal) transmitted from the user terminal 20. The received signal processing section 304 can be composed of a signal processor, a signal processing circuit or a signal processing apparatus described based on the common knowledge in the technical field according to the present invention.

The received signal processing section 304 outputs information decoded by the reception processing to the control section 301. When, for example, receiving the PUCCH including HARQ-ACK, the received signal processing section 304 outputs the HARQ-ACK to the control section 301. Furthermore, the received signal processing section 304 outputs the received signal and/or the signal after the reception processing to the measurement section 305.

The measurement section 305 performs measurement related to the received signal. The measurement section 305 can be composed of a measurement instrument, a measurement circuit or a measurement apparatus described based on the common knowledge in the technical field according to the present invention.

For example, the measurement section 305 may perform Radio Resource Management (RRM) measurement or Channel State Information (CSI) measurement based on the received signal. The measurement section 305 may measure, for example, received power (e.g., Reference Signal Received Power (RSRP)), received quality (e.g., Reference Signal Received Quality (RSRQ) or a Signal to Interference plus Noise Ratio (SINR)), a signal strength (e.g., Received Signal Strength Indicator (RSSI)) or channel information (e.g., CSI). The measurement section 305 may output a measurement result to the control section 301.

Furthermore, the control section 301 may control determination of a plurality of first radio resources (e.g., CCEs associated with highest AL candidates) respectively associated with a plurality of downlink control channel candidates (e.g., highest AL candidates) of a first aggregation level (e.g., highest AL), and control determination of a plurality of second radio resources (e.g., CCEs associated with lower AL candidates) of the above plurality of first radio resources respectively associated with a plurality of downlink control channel candidates (e.g., lower AL candidates) of a second aggregation level (e.g., lower AL) lower than the above first aggregation level.

<User Terminal>

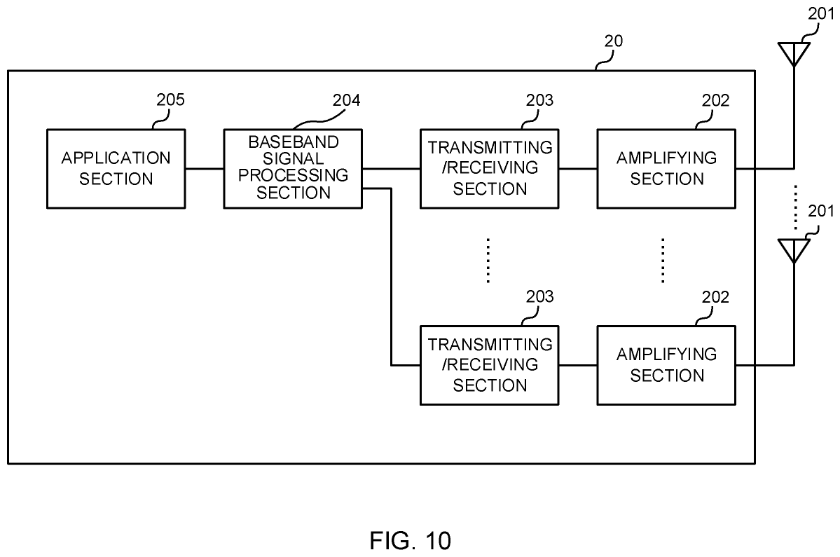

FIG. 10 is a diagram illustrating one example of an overall configuration of the user terminal according to the one embodiment of the present invention. The user terminal 20 includes pluralities of transmission/reception antennas 201, amplifying sections 202 and transmitting/receiving sections 203, a baseband signal processing section 204 and an application section 205. In this regard, the user terminal 20 only needs to be configured to include one or more of each of the transmission/reception antennas 201, the amplifying sections 202 and the transmitting/receiving sections 203.

Each amplifying section 202 amplifies a radio frequency signal received at each transmission/reception antenna 201. Each transmitting/receiving section 203 receives a downlink signal amplified by each amplifying section 202. Each transmitting/receiving section 203 performs frequency conversion on the received signal into a baseband signal, and outputs the baseband signal to the baseband signal processing section 204. The transmitting/receiving sections 203 can be composed of transmitters/receivers, transmission/reception circuits or transmission/reception apparatuses described based on the common knowledge in the technical field according to the present invention. In this regard, the transmitting/receiving sections 203 may be composed as an integrated transmitting/receiving section or may be composed of transmission sections and reception sections.

The baseband signal processing section 204 performs FFT processing, error correcting decoding, and retransmission control reception processing on the input baseband signal. The baseband signal processing section 204 transfers downlink user data to the application section 205. The application section 205 performs processing related to layers higher than a physical layer and an MAC layer. Furthermore, the baseband signal processing section 204 may transfer broadcast information of the downlink data, too, to the application section 205.

On the other hand, the application section 205 inputs uplink user data to the baseband signal processing section 204. The baseband signal processing section 204 performs retransmission control transmission processing (e.g., HARQ transmission processing), channel coding, precoding, Discrete Fourier Transform (DFT) processing and IFFT processing on the uplink user data, and transfers the uplink user data to each transmitting/receiving section 203. Each transmitting/receiving section 203 converts the baseband signal output from the baseband signal processing section 204 into a radio frequency range, and transmits a radio frequency signal. The radio frequency signal subjected to the frequency conversion by each transmitting/receiving section 203 is amplified by each amplifying section 202, and is transmitted from each transmission/reception antenna 201.

Furthermore, each transmitting/receiving section 203 may receive a downlink control channel (e.g., PDCCH).

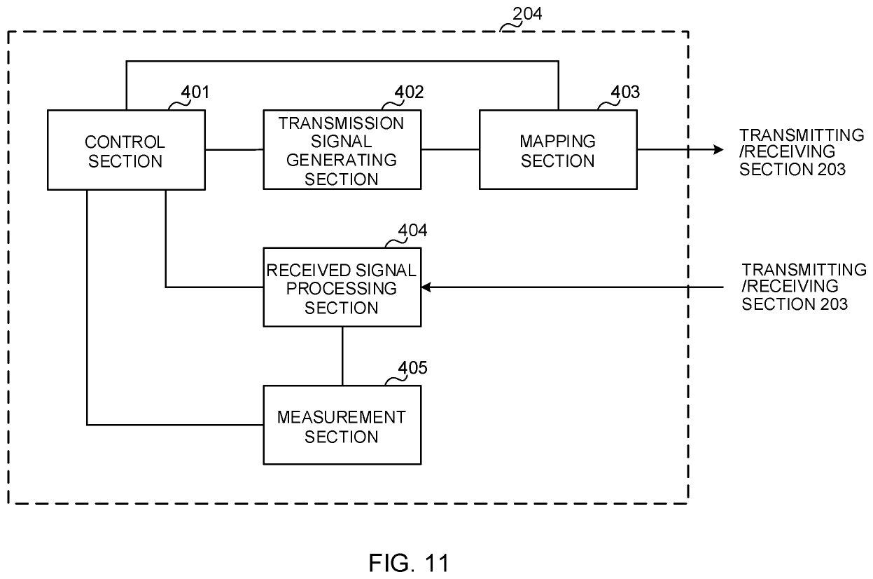

FIG. 11 is a diagram illustrating one example of a function configuration of the user terminal according to the one embodiment of the present invention. In addition, this example mainly illustrates function blocks of characteristic portions according to the present embodiment, and assumes that the user terminal 20 includes other function blocks, too, that are necessary for radio communication.

The baseband signal processing section 204 of the user terminal 20 includes at least a control section 401, a transmission signal generating section 402, a mapping section 403, a received signal processing section 404 and a measurement section 405. In addition, these components only need to be included in the user terminal 20, and part or all of the components may not be included in the baseband signal processing section 204.

The control section 401 controls the entire user terminal 20. The control section 401 can be composed of a controller, a control circuit or a control apparatus described based on the common knowledge in the technical field according to the present invention.

The control section 401 controls, for example, signal generation of the transmission signal generating section 402 and signal allocation of the mapping section 403. Furthermore, the control section 401 controls signal reception processing of the received signal processing section 404 and signal measurement of the measurement section 405.

The control section 401 obtains, from the received signal processing section 404, a downlink control signal and a downlink data signal that have been transmitted from the radio base station 10. The control section 401 controls generation of an uplink control signal and/or an uplink data signal based on a result obtained by deciding whether or not it is necessary to perform retransmission control on the downlink control signal and/or the downlink data signal.

Furthermore, when obtaining from the received signal processing section 404 various pieces of information notified from the radio base station 10, the control section 401 may update parameters used for control based on the various pieces of information.

The transmission signal generating section 402 generates an uplink signal (such as an uplink control signal, an uplink data signal or an uplink reference signal) based on an instruction from the control section 401, and outputs the uplink signal to the mapping section 403. The transmission signal generating section 402 can be composed of a signal generator, a signal generating circuit or a signal generating apparatus described based on the common knowledge in the technical field according to the present invention.

The transmission signal generating section 402 generates an uplink control signal related to transmission acknowledgement information and Channel State Information (CSI) based on, for example, the instruction from the control section 401. Furthermore, the transmission signal generating section 402 generates an uplink data signal based on the instruction from the control section 401. When, for example, the downlink control signal notified from the radio base station 10 includes a UL grant, the transmission signal generating section 402 is instructed by the control section 401 to generate an uplink data signal.

The mapping section 403 maps the uplink signal generated by the transmission signal generating section 402, on radio resources based on the instruction from the control section 401, and outputs the uplink signal to each transmitting/receiving section 203. The mapping section 403 can be composed of a mapper, a mapping circuit or a mapping apparatus described based on the common knowledge in the technical field according to the present invention.

The received signal processing section 404 performs reception processing (e.g., demapping, demodulation and decoding) on the received signal input from each transmitting/receiving section 203. In this regard, the received signal is, for example, a downlink signal (such as a downlink control signal, a downlink data signal or a downlink reference signal) transmitted from the radio base station 10. The received signal processing section 404 can be composed of a signal processor, a signal processing circuit or a signal processing apparatus described based on the common knowledge in the technical field according to the present invention. Furthermore, the received signal processing section 404 can compose the reception section according to the present invention.

The received signal processing section 404 outputs information decoded by the reception processing to the control section 401. The received signal processing section 404 outputs, for example, broadcast information, system information, an RRC signaling and DCI to the control section 401. Furthermore, the received signal processing section 404 outputs the received signal and/or the signal after the reception processing to the measurement section 405.

The measurement section 405 performs measurement related to the received signal. The measurement section 405 can be composed of a measurement instrument, a measurement circuit or a measurement apparatus described based on the common knowledge in the technical field according to the present invention.

For example, the measurement section 405 may perform RRM measurement or CSI measurement based on the received signal. The measurement section 405 may measure received power (e.g., RSRP), received quality (e.g., RSRQ or an SINR), a signal strength (e.g., RSSI) or channel information (e.g., CSI). The measurement section 405 may output a measurement result to the control section 401.

Furthermore, the control section 401 may control determination of a plurality of first radio resources (e.g., CCEs associated with highest AL candidates) respectively associated with a plurality of downlink control channel candidates (e.g., highest AL candidates) of the first aggregation level (e.g., highest AL), and control determination of a plurality of second radio resources (e.g., CCEs associated with lower AL candidates) of the above plurality of first radio resources respectively associated with a plurality of downlink control channel candidates (e.g., lower AL candidates) of the second aggregation level (e.g., lower AL) lower than the above first aggregation level.

Furthermore, a plurality of first radio resources and a plurality of second radio resources are each a plurality of control channel elements having contiguous numbers (e.g., CCE indices), and the numbers of the control channel elements in a plurality of first radio resources may be contiguous (e.g., FIG. 4A).

Furthermore, a plurality of first radio resources and a plurality of second radio resources are each a plurality of control channel elements having contiguous numbers (e.g., CCE indices), and the numbers of the control channel elements in a plurality of first radio resources may be non-contiguous (e.g., FIG. 4B).

Furthermore, a plurality of second radio resources (e.g., the CCEs associated with the lower AL candidates) may be equally distributed to a plurality of first radio resources (e.g., the CCEs associated with the highest AL candidates) (e.g., FIG. 3).

Furthermore, the control section 401 may determine the first aggregation level based on information related to the first aggregation level (e.g., a pseudo highest AL notified by a higher layer signaling) notified from the radio base station 10, and may not monitor downlink control channel candidates (e.g., pseudo highest AL candidates) of the first aggregation level (e.g., FIG. 6).

<Hardware Configuration>

In addition, the block diagrams used to describe the above embodiment illustrate blocks in function units. These function blocks (components) are realized by an optional combination of hardware and/or software. Furthermore, a method for realizing each function block is not limited in particular. That is, each function block may be realized by using one physically and/or logically coupled apparatus or may be realized by using a plurality of these apparatuses formed by connecting two or more physically and/or logically separate apparatuses directly and/or indirectly (by using, for example, wired connection and/or radio connection).

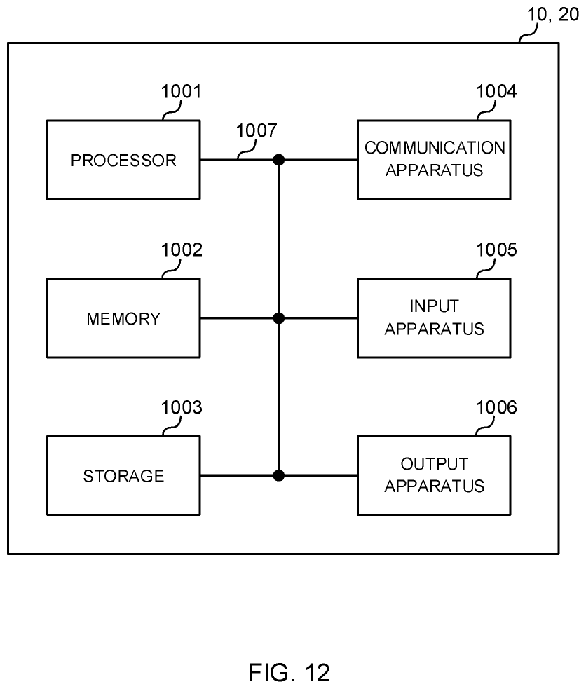

For example, the radio base station and the user terminal according to the one embodiment of the present invention may function as computers that perform processing of the radio communication method according to the present invention. FIG. 12 is a diagram illustrating one example of the hardware configurations of the radio base station and the user terminal according to the one embodiment of the present invention. The above-described radio base station 10 and user terminal 20 may be each physically configured as a computer apparatus that includes a processor 1001, a memory 1002, a storage 1003, a communication apparatus 1004, an input apparatus 1005, an output apparatus 1006 and a bus 1007.

In this regard, a word “apparatus” in the following description can be read as a circuit, a device or a unit. The hardware configurations of the radio base station 10 and the user terminal 20 may be configured to include one or a plurality of apparatuses illustrated in FIG. 12 or may be configured without including part of the apparatuses.

For example, FIG. 12 illustrates the only one processor 1001. However, there may be a plurality of processors. Furthermore, processing may be executed by 1 processor or processing may be executed by 1 or more processors concurrently or successively or by using another method. In addition, the processor 1001 may be implemented by 1 or more chips.

Each function of the radio base station 10 and the user terminal 20 is realized by, for example, causing hardware such as the processor 1001 and the memory 1002 to read given software (program), and thereby causing the processor 1001 to perform an operation, and control communication via the communication apparatus 1004 and reading and/or writing of data in the memory 1002 and the storage 1003.

The processor 1001 causes, for example, an operating system to operate to control the entire computer. The processor 1001 may be composed of a Central Processing Unit (CPU) including an interface for a peripheral apparatus, a control apparatus, an operation apparatus and a register. For example, the above-described baseband signal processing section 104 (204) and call processing section 105 may be realized by the processor 1001.

Furthermore, the processor 1001 reads programs (program codes), a software module or data from the storage 1003 and/or the communication apparatus 1004 out to the memory 1002, and executes various types of processing according to these programs, software module or data. As the programs, programs that cause the computer to execute at least part of the operations described in the above-described embodiment are used. For example, the control section 401 of the user terminal 20 may be realized by a control program that is stored in the memory 1002 and operates on the processor 1001, and other function blocks may be also realized likewise.

The memory 1002 is a computer-readable recording medium, and may be composed of at least one of, for example, a Read Only Memory (ROM), an Erasable Programmable ROM (EPROM), an Electrically EPROM (EEPROM), a Random Access Memory (RAM) and other appropriate storage media. The memory 1002 may be referred to as a register, a cache or a main memory (main storage apparatus). The memory 1002 can store programs (program codes) and a software module that can be executed to perform the radio communication method according to the one embodiment of the present invention.

The storage 1003 is a computer-readable recording medium, and may be composed of at least one of, for example, a flexible disk, a floppy (registered trademark) disk, a magnetooptical disk (e.g., a compact disk (Compact Disc ROM (CD-ROM)), a digital versatile disk and a Blu-ray (registered trademark) disk), a removable disk, a hard disk drive, a smart card, a flash memory device (e.g., a card, a stick or a key drive), a magnetic stripe, a database, a server and other appropriate storage media. The storage 1003 may be referred to as an auxiliary storage apparatus.

The communication apparatus 1004 is hardware (transmission/reception device) that performs communication between computers via wired and/or radio networks, and will be also referred to as, for example, a network device, a network controller, a network card and a communication module. The communication apparatus 1004 may be configured to include a high frequency switch, a duplexer, a filter and a frequency synthesizer to realize, for example, Frequency Division Duplex (FDD) and/or Time Division Duplex (TDD). For example, the above-described transmission/reception antennas 101 (201), amplifying sections 102 (202), transmitting/receiving sections 103 (203) and communication path interface 106 may be realized by the communication apparatus 1004.

The input apparatus 1005 is an input device (e.g., a keyboard, a mouse, a microphone, a switch, a button or a sensor) that accepts an input from an outside. The output apparatus 1006 is an output device (e.g., a display, a speaker or a Light Emitting Diode (LED) lamp) that sends an output to the outside. In addition, the input apparatus 1005 and the output apparatus 1006 may be an integrated component (e.g., touch panel).

Furthermore, each apparatus such as the processor 1001 or the memory 1002 is connected by the bus 1007 that communicates information. The bus 1007 may be composed by using a single bus or may be composed by using a bus that differs per apparatus.

Furthermore, the radio base station 10 and the user terminal 20 may be configured to include hardware such as a microprocessor, a Digital Signal Processor (DSP), an Application Specific Integrated Circuit (ASIC), a Programmable Logic Device (PLD) and a Field Programmable Gate Array (FPGA). The hardware may be used to realize part or all of each function block. For example, the processor 1001 may be implemented by using at least one of these types of hardware.

### Modified Example

In addition, each term that has been described in this description and/or each term that is necessary to understand this description may be replaced with terms having identical or similar meanings. For example, a channel and/or a symbol may be signals (signalings). Furthermore, a signal may be a message. A reference signal can be also abbreviated as an RS (Reference Signal), or may be also referred to as a pilot or a pilot signal depending on standards to be applied. Furthermore, a Component Carrier (CC) may be referred to as a cell, a frequency carrier and a carrier frequency.

Furthermore, a radio frame may include one or a plurality of durations (frames) in a time-domain. Each of one or a plurality of durations (frames) that composes a radio frame may be referred to as a subframe. Furthermore, the subframe may include one or a plurality of slots in the time-domain. The subframe may be a fixed time duration (e.g., 1 ms) that does not depend on the numerologies.

Furthermore, the slot may include one or a plurality of symbols (Orthogonal Frequency Division Multiplexing (OFDM) symbols or Single Carrier-Frequency Division Multiple Access (SC-FDMA) symbols) in the time-domain. Furthermore, the slot may be a time unit based on the numerologies. Furthermore, the slot may include a plurality of mini slots. Each mini slot may include one or a plurality of symbols in the time-domain. Furthermore, the mini slot may be referred to as a sub slot.

The radio frame, the subframe, the slot, the mini slot and the symbol each indicate a time unit for conveying signals. The other corresponding names may be used for the radio frame, the subframe, the slot, the mini slot and the symbol. For example, 1 subframe may be referred to as a Transmission Time Interval (TTI), a plurality of contiguous subframes may be referred to as TTIs, or 1 slot or 1 mini slot may be referred to as a TTI. That is, the subframe and/or the TTI may be a subframe (1 ms) according to legacy LTE, may be a duration (e.g., 1 to 13 symbols) shorter than 1 ms or may be a duration longer than 1 ms. In addition, a unit that indicates the TTI may be referred to as a slot or a mini slot instead of a subframe.

In this regard, the TTI refers to, for example, a minimum time unit of scheduling for radio communication. For example, in the LTE system, the radio base station performs scheduling for allocating radio resources (a frequency bandwidth or transmission power that can be used in each user terminal) in TTI units to each user terminal. In this regard, a definition of the TTI is not limited to this.

The TTI may be a transmission time unit of a channel-coded data packet (transport block), code block and/or codeword, or may be a processing unit of scheduling or link adaptation. In addition, when the TTI is given, a time period (e.g., the number of symbols) in which a transport block, a code block and/or a codeword are actually mapped may be shorter than the TTI.

In addition, when 1 slot or 1 mini slot is referred to as a TTI, 1 or more TTIs (i.e., 1 or more slots or 1 or more mini slots) may be a minimum time unit of scheduling. Furthermore, the number of slots (the number of mini slots) that compose a minimum time unit of the scheduling may be controlled.

The TTI having the time duration of 1 ms may be referred to as a general TTI (TTIs according to LTE Rel. 8 to 12), a normal TTI, a long TTI, a general subframe, a normal subframe or a long subframe. A TTI shorter than the general TTI may be referred to as a reduced TTI, a short TTI, a partial or fractional TTI, a reduced subframe, a short subframe, a mini slot or a subslot.

In addition, the long TTI (e.g., the general TTI or the subframe) may be read as a TTI having a time duration exceeding 1 ms, and the short TTI (e.g., the reduced TTI) may be read as a TTI having a TTI length less than the TTI length of the long TTI and equal to or more than 1 ms.

Resource Blocks (RBs) are resource allocation units of the time-domain and the frequency-domain, and may include one or a plurality of contiguous subcarriers in the frequency-domain. Furthermore, the RB may include one or a plurality of symbols in the time-domain or may have the length of 1 slot, 1 mini slot, 1 subframe or 1 TTI. 1 TTI or 1 subframe may each include one or a plurality of resource blocks. In this regard, one or a plurality of RBs may be referred to as a Physical Resource Block (PRB: Physical RB), a Sub-Carrier Group (SCG), a Resource Element Group (REG), a PRB pair or an RB pair.

Furthermore, the resource block may include one or a plurality of Resource Elements (REs). For example, 1 RE may be a radio resource domain of 1 subcarrier and 1 symbol.

In this regard, structures of the above-described radio frame, subframe, slot, mini slot and symbol are only exemplary structures. For example, configurations such as the number of subframes included in a radio frame, the number of slots per subframe or radio frame, the number of mini slots included in a slot, the numbers of symbols and RBs included in a slot or a mini slot, the number of subcarriers included in an RB, the number of symbols in a TTI, a symbol length and a Cyclic Prefix (CP) length can be variously changed.

Furthermore, the information and parameters described in this description may be expressed by using absolute values, may be expressed by using relative values with respect to given values or may be expressed by using other corresponding information. For example, a radio resource may be instructed by a given index.

Names used for parameters in this description are in no respect restrictive names. For example, various channels (the Physical Uplink Control Channel (PUCCH) and the Physical Downlink Control Channel (PDCCH)) and information elements can be identified based on various suitable names. Therefore, various names assigned to these various channels and information elements are in no respect restrictive names.

The information and the signals described in this description may be expressed by using one of various different techniques. For example, the data, the instructions, the commands, the information, the signals, the bits, the symbols and the chips mentioned in the above entire description may be expressed as voltages, currents, electromagnetic waves, magnetic fields or magnetic particles, optical fields or photons, or optional combinations of these.

Furthermore, the information and the signals can be output from a higher layer to a lower layer and/or from the lower layer to the higher layer. The information and the signals may be input and output via a plurality of network nodes.

The input and output information and signals may be stored in a specific location (e.g., memory) or may be managed by using a management table. The information and signals to be input and output can be overwritten, updated or additionally written. The output information and signals may be deleted. The input information and signals may be transmitted to other apparatuses.

Notification of information is not limited to the aspects/embodiment described in this description and may be performed by using other methods. For example, the information may be notified by a physical layer signaling (e.g., Downlink Control Information (DCI) and Uplink Control Information (UCI)), a higher layer signaling (e.g., a Radio Resource Control (RRC) signaling, broadcast information (Master Information Blocks (MIBs) and System Information Blocks (SIBs)), and a Medium Access Control (MAC) signaling), other signals or combinations of these.

In addition, the physical layer signaling may be referred to as Layer 1/Layer 2 (L1/L2) control information (L1/L2 control signal) or L1 control information (L1 control signal). Furthermore, the RRC signaling may be referred to as an RRC message, and may be, for example, an RRCConnectionSetup message or an RRCConnectionReconfiguration message. Furthermore, the MAC signaling may be notified by using, for example, an MAC Control Element (MAC CE).

Furthermore, notification of given information (e.g., notification of “being X”) is not limited to explicit notification, and may be performed implicitly (by, for example, not notifying this given information or by notifying another information). Decision may be made based on a value (0 or 1) expressed as 1 bit, may be made based on a boolean expressed as true or false or may be made by comparing numerical values (by, for example, making comparison with a given value).

Irrespectively of whether software is referred to as software, firmware, middleware, a microcode or a hardware description language or as other names, the software should be widely interpreted to mean a command, a command set, a code, a code segment, a program code, a program, a subprogram, a software module, an application, a software application, a software package, a routine, a subroutine, an object, an executable file, an execution thread, a procedure or a function.

Furthermore, software, commands and information may be transmitted and received via transmission media. When, for example, the software is transmitted from websites, servers or other remote sources by using wired techniques (e.g., coaxial cables, optical fiber cables, twisted pairs and Digital Subscriber Lines (DSLs)) and/or radio techniques (e.g., infrared rays and microwaves), these wired techniques and/or radio techniques are included in a definition of the transmission media.

The terms “system” and “network” used in this description are compatibly used.

In this description, the terms “Base Station (BS)”, “radio base station”, “eNB”, “gNB”, “cell”, “sector”, “cell group”, “carrier” and “component carrier” can be compatibly used. The base station will be also referred to as a term such as a fixed station, a NodeB, an eNodeB (eNB), an access point, a transmission point, a reception point, a femtocell or a small cell in some cases.

The base station can accommodate one or a plurality of (e.g., three) cells (also referred to as sectors). When the base station accommodates a plurality of cells, an entire coverage area of the base station can be partitioned into a plurality of smaller areas. Each smaller area can also provide communication service via a base station subsystem (e.g., indoor small base station (RRH: Remote Radio Head)). The term “cell” or “sector” indicates part or the entirety of the coverage area of the base station and/or the base station subsystem that provide communication service in this coverage.

In this description, the terms “Mobile Station (MS)”, “user terminal”, “User Equipment (UE)” and “terminal” can be compatibly used. The base station will be also referred to as a term such as a fixed station, a NodeB, an eNodeB (eNB), an access point, a transmission point, a reception point, a femtocell or a small cell in some cases.

The mobile station will be also referred to by a person skilled in the art as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client or some other appropriate terms in some cases.

Furthermore, the radio base station in this description may be read as the user terminal. For example, each aspect/embodiment of the present invention may be applied to a configuration where communication between the radio base station and the user terminal is replaced with communication between a plurality of user terminals (D2D: Device-to-Device). In this case, the user terminal 20 may be configured to include the functions of the above-described radio base station 10. Furthermore, words such as “uplink” and “downlink” may be read as a “side”. For example, the uplink channel may be read as a side channel.

Similarly, the user terminal in this description may be read as the radio base station. In this case, the radio base station 10 may be configured to include the functions of the above-described user terminal 20.

In this description, operations performed by the base station are performed by an upper node of this base station depending on cases. Obviously, in a network including one or a plurality of network nodes including the base stations, various operations performed to communicate with a terminal can be performed by base stations, one or more network nodes (that are supposed to be, for example, Mobility Management Entities (MMEs) or Serving-Gateways (S-GWs) yet are not limited to these) other than the base stations or a combination of these.

Each aspect/embodiment described in this description may be used alone, may be used in combination or may be switched and used when carried out. Furthermore, orders of the processing procedures, the sequences and the flowchart according to each aspect/embodiment described in this description may be rearranged unless contradictions arise. For example, the method described in this description presents various step elements in an exemplary order and is not limited to the presented specific order.

Each aspect/embodiment described in this description may be applied to Long Term Evolution (LTE), LTE-Advanced (LTE-A), LTE-Beyond (LTE-B), SUPER 3G, IMT-Advanced, the 4th generation mobile communication system (4G), the 5th generation mobile communication system (5G), Future Radio Access (FRA), the New Radio Access Technology (New-RAT), New Radio (NR), New radio access (NX), Future generation radio access (FX), Global System for Mobile communications (GSM) (registered trademark), CDMA2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other appropriate radio communication methods and/or next-generation systems that are expanded based on these systems.

The phrase “based on” used in this description does not mean “based only on” unless specified otherwise. In other words, the phrase “based on” means both of “based only on” and “based at least on”.

Every reference to elements that use names such as “first” and “second” used in this description does not generally limit the quantity or the order of these elements. These names can be used in this description as a convenient method for distinguishing between two or more elements. Hence, the reference to the first and second elements does not mean that only two elements can be employed or the first element should precede the second element in some way.

The term “deciding (determining)” used in this description includes diverse operations in some cases. For example, “deciding (determining)” may be regarded to “decide (determine)” calculating, computing, processing, deriving, investigating, looking up (e.g., looking up in a table, a database or another data structure) and ascertaining. Furthermore, “deciding (determining)” may be regarded to “decide (determine)” receiving (e.g., receiving information), transmitting (e.g., transmitting information), input, output and accessing (e.g., accessing data in a memory). Furthermore, “deciding (determining)” may be regarded to “decide (determine)” resolving, selecting, choosing, establishing and comparing. That is, “deciding (determining)” may be regarded to “decide (determine)” some operation.

The words “connected” and “coupled” used in this description or every modification of these words can mean every direct or indirect connection or coupling between 2 or more elements, and can include that 1 or more intermediate elements exist between the two elements “connected” or “coupled” with each other. The elements may be coupled or connected physically or logically or by a combination of the physical and logical connections. For example, “connection” may be read as “access”.

It can be understood in this description that, when connected, the two elements are “connected” or “coupled” with each other by using 1 or more electric wires, cables and/or printed electrical connection, and by using electromagnetic energy having wavelengths in radio frequency domains, microwave domains and/or (both of visible and invisible) light domains in some non-restrictive and non-comprehensive examples.

A sentence that “A and B are different” in this description may mean that “A and B are different from each other”. Words such as “separate” and “coupled” may be also interpreted in a similar manner.

When the words “including” and “comprising” and modifications of these words are used in this description or the claims, these words intend to be comprehensive similar to the word “having”. Furthermore, the word “or” used in this description or the claims intends not to be an exclusive OR.

The present invention has been described in detail above. However, it is obvious for a person skilled in the art that the present invention is not limited to the embodiment described in this description. The present invention can be carried out as modified and changed aspects without departing from the gist and the scope of the present invention defined based on the recitation of the claims. Accordingly, the disclosure of this description is intended for exemplary explanation, and does not bring any restrictive meaning to the present invention.

1. A user terminal comprising:
a receiving section that receives a downlink control channel; and
a control section that controls determination of a plurality of first radio resources respectively associated with a plurality of downlink control channel candidates of a first aggregation level, and controls determination of a plurality of second radio resources of the plurality of first radio resources, the plurality of second radio resources being respectively associated with a plurality of downlink control channel candidates of a second aggregation level lower than the first aggregation level.

2. The user terminal according to claim 1, wherein
the plurality of first radio resources and the plurality of second radio resources are each a plurality of control channel elements having contiguous numbers, and
numbers of control channel elements in the plurality of first radio resources are contiguous.

3. The user terminal according to claim 1, wherein
the plurality of first radio resources and the plurality of second radio resources are each a plurality of control channel elements having contiguous numbers, and
numbers of control channel elements in the plurality of first radio resources are non-contiguous.

4. The user terminal according to claim 1, wherein the plurality of second radio resources are equally distributed to the plurality of first radio resources.

5. The user terminal according to claim 1, wherein
the receiving section receives information related to the first aggregation level, and
the control section determines the first aggregation level based on the information, and does not monitor downlink control channel candidates of the first aggregation level.

6. A radio communication method comprising:
at a user terminal, receiving a downlink control channel; and
at the user terminal, controlling determination of a plurality of first radio resources respectively associated with a plurality of downlink control channel candidates of a first aggregation level, and controlling determination of a plurality of second radio resources of the plurality of first radio resources, the plurality of second radio resources being respectively associated with a plurality of downlink control channel candidates of a second aggregation level lower than the first aggregation level.

7. The user terminal according to claim 2, wherein the plurality of second radio resources are equally distributed to the plurality of first radio resources.

8. The user terminal according to claim 3, wherein the plurality of second radio resources are equally distributed to the plurality of first radio resources.

9. The user terminal according to claim 2, wherein
the receiving section receives information related to the first aggregation level, and
the control section determines the first aggregation level based on the information, and does not monitor downlink control channel candidates of the first aggregation level.

10. The user terminal according to claim 3, wherein
the receiving section receives information related to the first aggregation level, and
the control section determines the first aggregation level based on the information, and does not monitor downlink control channel candidates of the first aggregation level.

11. The user terminal according to claim 4, wherein
the receiving section receives information related to the first aggregation level, and
the control section determines the first aggregation level based on the information, and does not monitor downlink control channel candidates of the first aggregation level.
